(19) United States
(12) Patent Application Publication
(10) Pub. No.: US 2020/0289864 A1
(43) Pub. Date: Sep. 17, 2020

(54) MULTIFUNCTIONAL FITNESS DEVICE WITH GRIP STRENGTH TRAINING MODE

(71) Applicants: Richard LIN, Taichung City (TW); LONG TRAIN ENTERPRISE CO., LTD., Taichung City (TW)

(72) Inventor: Richard LIN, Taichung City (TW)

(21) Appl. No.: 16/353,613

(22) Filed: Mar. 14, 2019

(51) Int. Cl. A63B 21/02; A63B 23/16; A63B 21/045; A63B 21/00; A63B 23/035; F16M 13/06

(52) U.S. Cl. CPC A63B 21/025; A63B 23/16; A63B 21/045; F16M 11/22; A63B 23/0355; F16M 13/06; A63B 21/4035

(57) ABSTRACT

A multifunctional fitness device with grip strength training mode includes: a spiral elastic part with convex stretch sections which extend in different directions; each of the two bent rod grips includes a soft sleeve and a bent rod with a connecting end, a tail end and a bent section, and the connecting end extends integrally from the convex stretch section of the spiral elastic part, and the bent section is in a U shape; a hood component includes first and second housings combined in a relative screwing relationship and provided respectively with a convex stretch pipe, for which the convex stretch section passes through; and the included angle between the bent sections of the bent rod grips is 30°-80°; the contour formed by the connecting end, bent section and tail end of the bent rod grip is smaller than the grip range of the adult palm.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

### 1. Field of the Invention

The present invention relates to an exercise fitness device, and more particularly to an innovative multifunctional fitness device with grip strength training mode.

### 2. Description of Related Art Including Information Disclosed Under 37 CFR 1.97 and 37 CFR 1.98.

At present, there are many kinds of exercise fitness devices available on the market, and the exercise fitness device targeted by the present invention is mainly related to the hand muscle exercise fitness function.

The current exercise fitness devices with hand muscle exercise fitness functions are mainly the wrist developer and clasp-hands device; however, the current structural design of these exercise fitness devices is generally more suitable for users with strong muscle strength, but difficult for other numerous people with relatively weak muscle strength (such as seniors, children and postoperative rehabilitation). For example, the aforementioned exercise fitness devices such as wrist developers and clasp-hands devices still have practical difficulties in practical use, high difficulty and difficulty in generating a sense of accomplishment, and difficulty in continuing to attract use and other disadvantages and problems. Based on this point, how to develop a exercise fitness device that is easier to use and more diverse in function is an important technical issue, which is worthy of continuous attention in the relevant industry.

### BRIEF SUMMARY OF THE INVENTION

The present invention mainly aims to provide a multifunctional fitness device with grip strength training mode, and the technical problem to be solved aims at how to develop a new type of fitness device structure which is more ideal and practical for innovation breakthrough.

Based on the foregoing objective, the present invention provides a multifunctional fitness device with grip strength training mode, it comprises: a spiral elastic part, which is a spiral rod type, and the two opposite ends thereof extend in different directions respectively to form two convex stretch sections; the two bent rod grips are respectively connected to the spiral elastic part, and each of the bent rod grips comprises a bent rod and a soft sleeve covering the outside of the bent d rod, the bent rod has a connecting end, a tail end and a bent section between the connecting end and the tail end, wherein the connecting end is integrally extended from the spiral elastic part to the corresponding convex stretch section, the bent section is in a U-shaped reversely folded state to form a void part therein, and forms an arrangement relationship in which the connecting end and the tail end are adjacent to each other, and forms a corresponding relationship of a connecting end of one of the bent rod grips and the tail end of the other bent rod grips; a hood component is assembled outside the spiral elastic part, and the hood component includes a first housing and a second housing that are combined with each other in a relative screwing relationship, and the first housing and the second housing are provided respectively with a convex stretch pipe, for which the two convex stretch sections of the spiral elastic part pass through; and the angle between the bent sections of the two bent rod grips is 30°-80°; the contour formed by the connecting end, bent section and tail end of the bent rod grip is smaller than the grip range of the adult palm.

With this innovative and unique design, the present invention can provide the user with a variety of functions of the fitness device according to the prior art, and the practical application can provide a palm movement mode of the two-handed control, or the grip movement can be operated simultaneously by two hands or one hand, or the opening and closing force application movement of other parts of the body can be operated. Besides, it is also suitable for use as a reclining stand for handheld electronic device, thereby providing the practical advancement and better industrial utilization.

### BRIEF DESCRIPTION OF THE SEVERAL VIEWS OF THE DRAWINGS

FIG. 1 is a three-dimensional outside view of the preferred embodiment of the present invention.

FIG. 2 is a three-dimensional perspective view of the preferred embodiment of the present invention.

FIG. 3 is a front view of the preferred embodiment of the present invention.

FIG. 4 is a sectional view of local structure of the preferred embodiment of the present invention 1.

FIG. 5 is a sectional view of local structure of the preferred embodiment of the present invention 2.

FIG. 6 is a use status diagram of the preferred embodiment of the present invention 1.

FIG. 7 is a use status diagram of the preferred embodiment of the present invention 2.

FIG. 8 is a use status diagram of the preferred embodiment of the present invention 3.

FIG. 9 is a use status diagram of the preferred embodiment of the present invention 4.

### DETAILED DESCRIPTION OF THE INVENTION

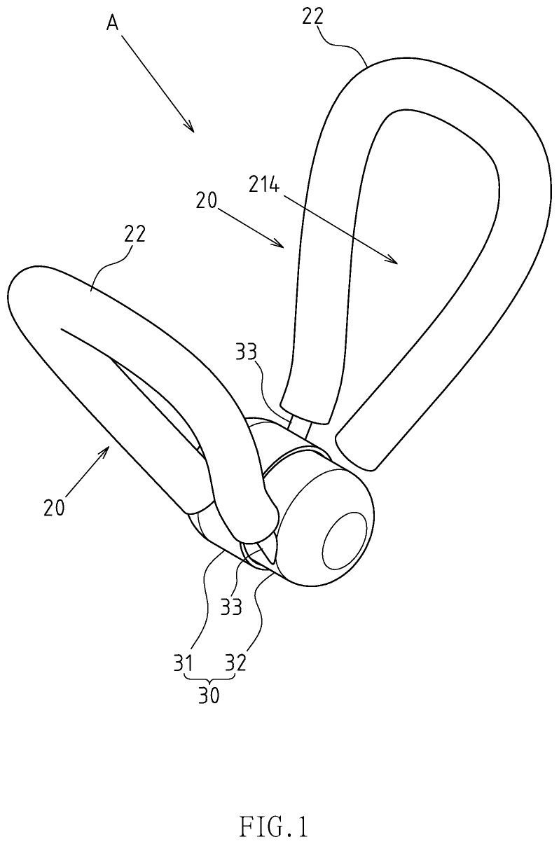

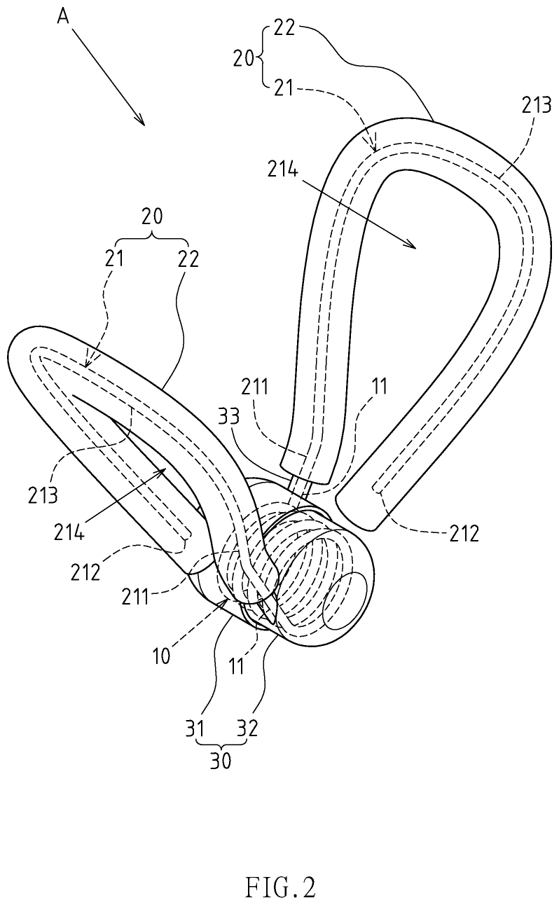

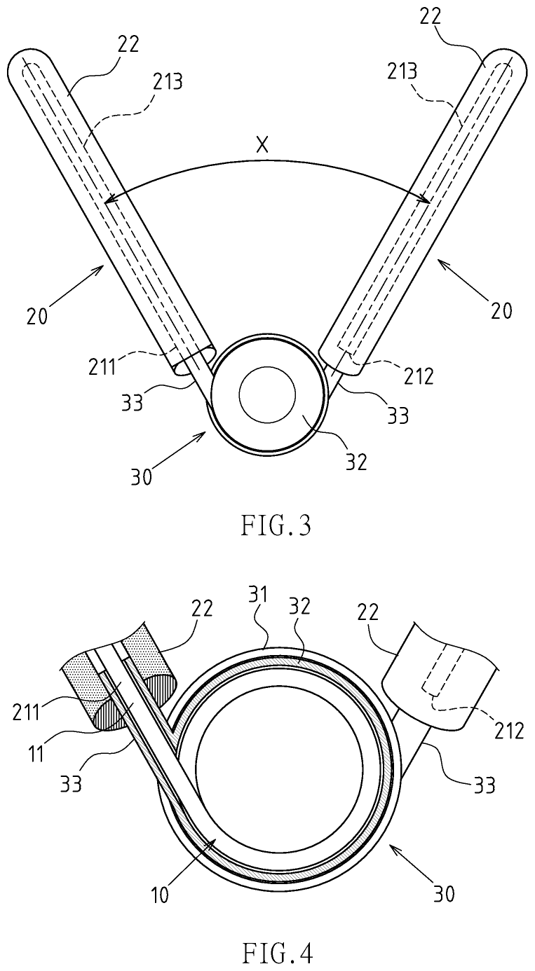

Referring to FIG. 1-5 for the preferred embodiments of the multifunctional fitness device with grip strength training mode of the present invention, but the embodiments are for illustrative purposes only, and the patent application is not limited by this structure.

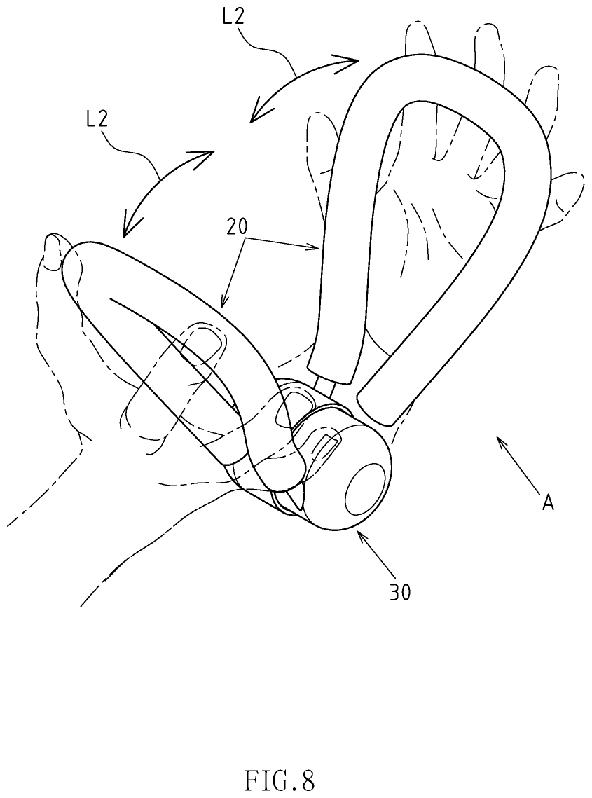

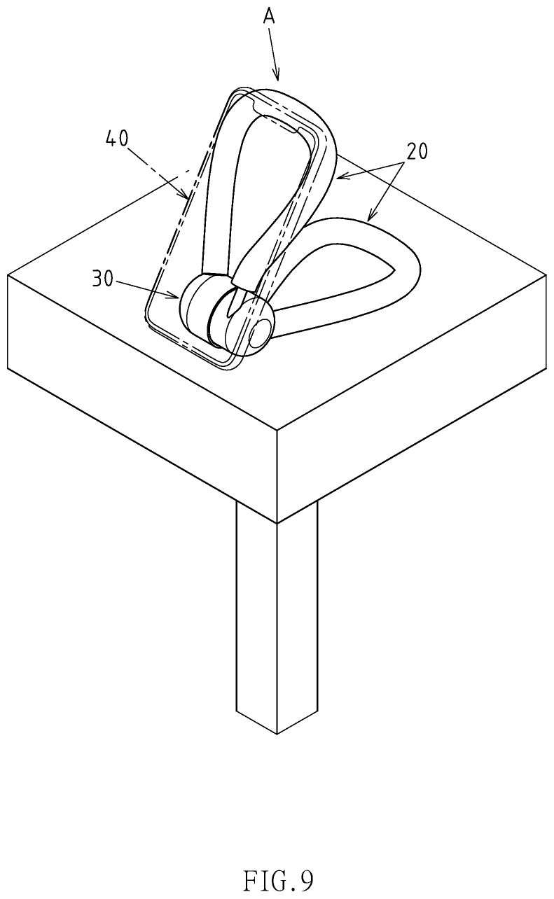

The multifunctional fitness device A comprises the following parts: a spiral elastic part 10, which is a spiral rod type, the two opposite ends of which extend in different directions to form two convex stretch sections 11; two bent rod grips 20 are connected to the spiral elastic part 10, each bent rod grip 20 includes a bent rod 21 and a soft sleeve 22 wrapped around the outside of the bent rod 21 (may be, but not limited to, plastic foaming or rubber material), wherein the bent rod 21 comprises a connecting end 211, a tail end 212 and a bent section 213 between the connecting end 211 and the tail end 212, wherein the connecting end 211 is integrated and extended with corresponding convex stretch section 11 from the spiral elastic part 10, the bent section 213 shows a U-shaped reversed shape and forms a void part 214 therein, and forms an arrangement relationship between the connecting end 211 and the tail end 212, and forms a corresponding relationship between the connecting end 211 of one bent rod grips 20 and another bent rod grip 20 of the tail end 212; hood component 30, a hood component 30 is assembled and wrapped at the outside of the spiral elastic part 10, the hood component 30 includes a first housing 31 and a second housing 32 which are combined with each other in a relative screwing relationship, and the first housing 31 and one second housings 32 are respectively provided with a convex stretch pipe 33 for that two convex stretch sections 11 of the spiral elastic part 10 pass through; and wherein there is an included angle X between the bent section 213 of the two bent rod grips 20 (as shown in FIG. 3), the included angle X is 30°-80°; and as shown in FIG. 8, the contour formed by the connecting end 211, the bent section 213 and the tail end 212 of each of the bent rod grips 20 must be smaller than the grip range of the adult palm.

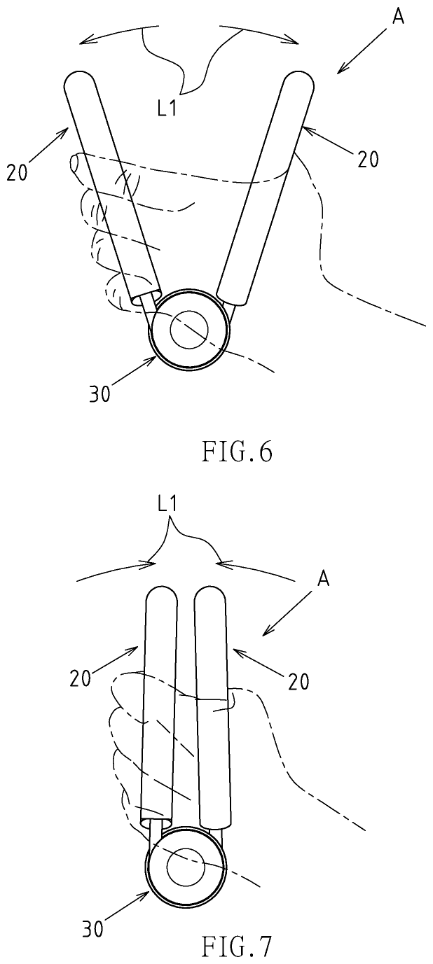

With the above structural composition and technical features, the multifunctional fitness device A disclosed in the present invention has various functions in practical use, and further enumerated as follows: first, as shown in FIGS. 6-7, because an included angle X (as shown in FIG. 3) between the bent section 213 of the two bent rod grips 20 is an acute angle between 30° and 80°, therefore, the user can use two hands to hold both sides of the bent section 213 of the two bent rod grip 20 (note: because the figure is a lateral viewing angle, so only the left hand is seen), and then the opening and closing action of the grip strength is performed. (as indicated by Arrow L1), in this action, since the user use two hands to apply the force synchronously, the difficulty of operation is relatively low even for a group of people with weak muscle strength (such as seniors, child, postoperative rehabilitation). It does not cause a sense of rejection, and the sense of accomplishment is relatively high and easy to use continuously; as shown in FIG. 8, the multifunctional fitness device A can also provide the user with a clasp-hands type exercise (as indicated by Arrow L2), and the user can open the palms of the hands respectively to grasp the opposite outside of the bent section 213 of two bent rod grips 20, and then perform a opening and closing exercise of a clasp-hands type, which can exercise the muscles of the palm, wrist and arm; as also shown in FIG. 9, the multifunctional fitness device A can provide a exercise fitness function, and can also be placed on a table at one side with the bent rod grip 20 as a base, at this time, because the bent section 213 of the two bent rod grips 20 is in an acute angle, so that the bent rod grip 20 on the other side of the upward direction, the bent curved shape formed by the bent section 213 is just suitable as a reclining stand for a handheld electronic device 40 (such as smart phone, tablet computer, etc.); in addition, the multifunctional fitness device A can also provide the user with exercise of other modes, for example, it is placed between the user's left and right thighs for closing and opening exercise, or placed between the forearm and the waist of the user for closing and opening exercise, or the single hand is gripped on the same side of the two bent rod grips 20 for grip strength exercise, all are the exercise fitness modes applied in the present invention, that is, not listed one by one; as can be seen from the above description, compared with the existing wrist builders, such as clasp-hands fitness device and arm fitness device, the multifunctional fitness device A is greatly improved in affinity and is more suitable for the general consumers.

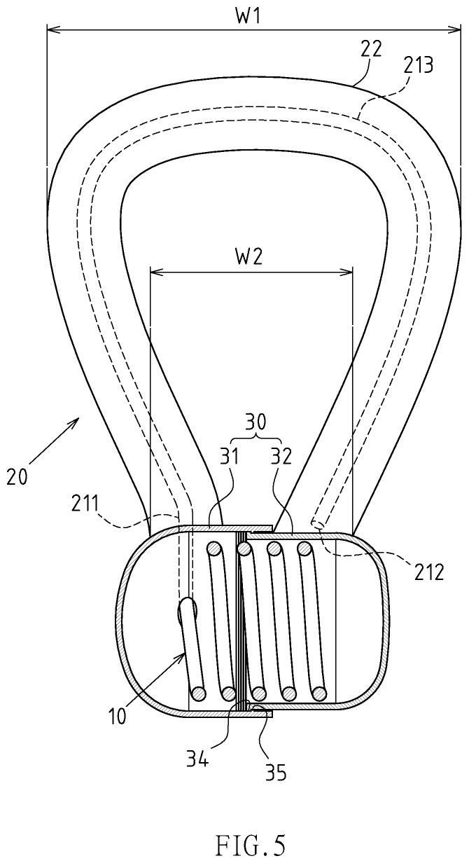

As shown in FIG. 5, in this example, the width W1 of the bent section 213 with a U-shaped reverse-folded part is greater than the width W2 of the connecting end 211 and the tail end 212; the advantage of the embodiment disclosed in this example is that the part of the bent section 213 with a U-shaped reversed shape has a relatively wide area, so that when the user wants to perform the clasp-hands exercise as disclosed in FIG. 8, it can provide a shape suitable for the palm of the user to grasp; or, when the multifunctional fitness device A provides the reclining stand for the handheld electronic device 40 (such as a smart phone, tablet computer, etc.) as disclosed in FIG. 9, a stable placement area can be obtained.

As shown in FIG. 5, in this example, the first housing 31 and the second housing 32 of the hood component 30 are respectively provided with a ring groove 34 and a ring flange 35, the ring flange 35 is embedded into the ring groove 34 in a loosely fitted state, so that the first housing 31 and the second housing 32 are rotatable relative to each other; thereby, when the two bent rod grips 20 are forced to generate relative the opening and closing movement, the first housing 31 and the second housing 32 can be rotated accordingly.

I claim:

1. A multifunctional fitness device with grip strength training mode, the multifunctional fitness device includes:
a spiral elastic part, which is a spiral rod type, and the two opposite ends thereof extend in different directions respectively to form two convex stretch sections;
the two bent rod grips are respectively connected to the spiral elastic part, and each of the bent rod grips comprises a bent rod and a soft sleeve covering the outside of the bent d rod, the bent rod has a connecting end, a tail end and a bent section between the connecting end and the tail end, wherein the connecting end is integrally extended from the spiral elastic part to the corresponding convex stretch section, the bent section is in a U-shaped reversely folded state to form a void part therein, and forms an arrangement relationship in which the connecting end and the tail end are adjacent to each other, and forms a corresponding relationship of a connecting end of one of the bent rod grips and the tail end of the other bent rod grips; and
a hood component is assembled outside the spiral elastic part, and the hood component includes a first housing and a second housing that are combined with each other in a relative screwing relationship, and the first housing and the second housing are provided respectively with a convex stretch pipe, for which the two convex stretch sections of the spiral elastic part pass through;
and the included angle X between the bent sections of the two bent rod grips is 30°-80°;
and the contour formed by the connecting end, bent section and tail end of the bent rod grip is smaller than the grip range of the adult palm.

2. The multifunctional fitness device with grip strength training mode defined in claim 1, wherein a width W1 of the bent section with a U-shaped reverse-folded part is greater than a width W2 of the connecting end and the tail end;

3. The multifunctional fitness device with grip strength training mode defined in claim 1, wherein the first housing and the second housing of the hood component are respectively provided with a ring groove and a ring flange, the ring flange is embedded into the ring groove in a loosely fitted state, so that the first housing and the second housing are rotatable relative to each other.

4. The multifunctional fitness device with grip strength training mode defined in claim 2, wherein the first housing and the second housing of the hood component are respectively provided with a ring groove and a ring flange, the ring flange is embedded into the ring groove in a loosely fitted state, so that the first housing and the second housing are rotatable relative to each other.
